(19) United States
(12) Patent Application Publication
(10) Pub. No.: US 2011/0115429 A1
(43) Pub. Date: May 19, 2011

(54) Wireless Charging Adapter Compatible With Wall Charger And Wireless Charging Plate

(75) Inventors: Timo Tapani TOIVOLA, Turku (FI); Juhani Valdemar KARI, Lieto (FI)

(73) Assignee: Nokia Corporation, Espoo (FI)

(21) Appl. No.: 12/618,276

(22) Filed: Nov. 13, 2009

(51) Int. Cl. H02J 7/00; H01F 27/42

(52) U.S. Cl. 320/108; 307/104

(57) ABSTRACT

Example embodiments are disclosed for wirelessly charging batteries of relatively small devices, such as wireless headsets, using a relatively large wireless charging plate. In example embodiments of the invention, a high permeability magnetic field concentrator has a generally frusto-conical shape with a base at one end, tapering down to a pole at the opposite end. The concentrator is configured to concentrate magnetic flux at a lower flux density incident at the base from a proximate power transmitting coil having a relatively large surface area in a wireless charger. The magnetic flux exits at a higher flux density at the pole end proximate to a power receiving coil having a relatively small surface area in a utilization device. The higher density magnetic flux couples with the power receiving coil, using contact-less electromagnetic induction. The wireless charger may be a charging plate and the utilization device may be a wireless headset. The magnetic field concentrator enables gathering sufficient power by the relatively small power receiving coil to charge the headset's batteries within a reasonable time.

### FIELD

The technical field relates to wireless charging of batteries in portable devices. More particularly, the technical field relates to techniques for wirelessly charging batteries of relatively small rechargeable devices, such as wireless headsets.

### BACKGROUND

Rechargeable batteries in cellular phones and other portable communication devices, such as NiCd, nickel-metal hydride (NiMH), Lithium-ion, and Lithium-Polymer batteries, can be recharged with household alternating current (AC) power coupled through a voltage reduction transformer, an alternating-to-direct current converter, and appropriate battery monitoring and charging circuits. They can also be recharged with a 12-volt cigarette lighter socket provided in an automobile coupled through a DC voltage reduction circuit and appropriate battery monitoring and charging circuits. However, in both cases, the portable communication device must be plugged into a household AC power source such as a wall charger or into the automobile power source, limiting the mobility of the communication device.

Recently, wireless charging has become available for rechargeable batteries in cellular phones and other portable communication devices, using contact-less electromagnetic induction. A power source circuit in a wireless charging device drives a resonant frequency oscillator that produces a source alternating current in a frequency range between 50 kHz and 20 MHz, which is driven through a transmitting coil in the charging device. The alternating magnetic field produced by the transmitting coil inductively couples with a corresponding receiving coil in the cellular phone or other portable communication device, thereby producing a corresponding induced alternating current that drives an oscillator at its resonant frequency in the range between 50 kHz and 20 MHz to produce an output AC voltage. A conversion circuit in the cellular phone or other portable communication devices, uses a transformer to adjust the output AC voltage, an alternating-to-direct current converter, and appropriate battery monitoring and charging circuits to produce an appropriate DC charging voltage for the rechargeable battery. The wireless charger is generally shaped as a charging plate and the cell phone or other rechargeable device is laid on the plate during the charging operation.

With the advent of Bluetooth technology, wireless headsets containing an earpiece and microphone may be worn by the user, which use the Bluetooth wireless connection to the user's cell phone to enable conducting telephone conversations. The headpiece requires its own battery for its operation and rechargeable batteries are economical to avoid frequent replacement. However, wireless chargers that are in the form of a charging plate designed for recharging cell phone batteries, have a charging coil surface area much larger than the overall size of a headset. The relatively small footprint of a headset when positioned on the charging coil of a charging plate, presents too small an area to gather sufficient power to charge the headset's batteries within a reasonable time.

### SUMMARY

Example embodiments are disclosed for wirelessly charging batteries of relatively small rechargeable devices, such as wireless headsets, using a relatively large wireless charging plate. In example embodiments of the invention, a high permeability magnetic field concentrator has an optimized shape to concentrate the magnetic field. Non-limiting examples include a generally frusto-conical shape and a generally toroidal shape. An example frusto-conical shape for a magnetic field concentrator has a base at one end, tapering down to a pole at the opposite end. The example frusto-conical shaped concentrator is configured to concentrate an applied magnetic flux at a lower flux density incident at the base from a proximate power transmitting coil having a relatively large surface area in a wireless charger. The magnetic flux exits at a higher flux density at the pole end proximate to a power receiving coil having a relatively small surface area in a utilization device. The higher density magnetic flux couples with the power receiving coil, using contact-less electromagnetic induction. The wireless charger may be a charging plate and the utilization device may be a small rechargeable device, such as wireless headset. The magnetic field concentrator enables gathering sufficient power by the relatively small power receiving coil to charge the small rechargeable device's batteries within a reasonable time.

An example toroidal shape for a magnetic field concentrator has a generally circular body with a base and an upper surface, surrounding a generally circular aperture. The example toroidal shaped concentrator is configured to concentrate an applied magnetic flux at a lower flux density incident at the base from a proximate power transmitting coil having a relatively large surface area in a wireless charger. The magnetic flux exits at a higher flux density at the upper surface proximate to a power receiving coil having a relatively small surface area in a utilization device. The higher density magnetic flux couples with the power receiving coil, using contact-less electromagnetic induction.

A variety of small rechargeable devices use rechargeable batteries that may be recharged by embodiments of the invention, including wireless headsets, hearing aids, cardiac pacemakers, small medical devices such as a pill-sized radio and camera for gastrointestinal diagnosis, small dental devices such as an ultraviolet light source for curing polymer dental fillings, wireless mouse, wearable ubiquitous computing devices, small surveillance cameras, illuminated jewelry, battery-operated toys, and the like.

In example embodiments of the frusto-conical shaped concentrator, charger coils may be wrapped around the pole end of the concentrator, the coils being substantially concentric with the frusto-conical shape. The coils are configured to conduct alternating current in a frequency range between 50 kHz and 20 MHz to produce an alternating magnetic field to inductively couple with the proximate receiving coil at the pole end of the concentrator, using contact-less electromagnetic induction. The magnetic field concentrator enables gathering sufficient power by the relatively small power receiving coil to charge the small rechargeable device's batteries within a reasonable time.

The high permeability magnetic field concentrator has an optimized shape to concentrate the magnetic field. Non-limiting examples of the magnetic field concentrator include a generally frusto-conical shape and a generally toroidal shape, but other shapes may be employed to concentrate the magnetic field to enable small rechargeable devices having a small area to gather sufficient power to charge the device's batteries within a reasonable time.

In example embodiments of the invention, a high permeability magnetic field guide within the small rechargeable device, directs the magnetic field concentrated by the high permeability magnetic field concentrator into the power receiving coil. The high permeability magnetic field guide reduces fringe fields and urges the concentrated magnetic field in the power receiving coil into more nearly parallel paths in the small rechargeable device. The magnetic field guide has an optimal shape to direct the magnetic field of the concentrator into the power receiving coil. Non-limiting examples include a generally coin-shaped magnetic field guide with the base of the guide juxtaposed with the concentrator. The high permeability magnetic field guide directs the concentrated magnetic flux incident at the flat bottomed base of the guide to reduce fringe fields and urge the concentrated magnetic field in the power receiving coil into more nearly parallel paths.

In example embodiments of the invention, an alternate example embodiment may have two coin-shaped magnetic field guides between which is sandwiched the printed wire receiving coil, the guide directing the magnetic field into the printed wire coil to enhance the inductive coupling of the power receiving printed wire coil.

An example ring-shaped magnetic field guide with a base, and around the ring is wrapped the power receiving coil so as to be coplanar with the base and juxtaposed with the concentrator. The high permeability magnetic field guide directs the concentrated magnetic flux incident at the base of the guide to reduce fringe fields and urge the concentrated magnetic field in the power receiving coil into more nearly parallel paths.

In example embodiments of the invention, the charger coil produces an alternating magnetic field below the base of the concentrator, to inductively couple with a proximate power receiving coil of a device such as a cell phone, positioned below the base of the concentrator, using contact-less electromagnetic induction.

In example embodiments of the invention, a housing covers the concentrator from the base toward the top and forms a socket cavity at the top, configured to accept insertion of the power receiving coil of a small rechargeable device.

In example embodiments of the invention, the magnetic field concentrator may include miniaturized charger circuits on a printed wiring board, to perform the functions of the circuits that drive the charger coils wrapped around the pole end of the concentrator. The power source may be a wall charger, mains, or a battery pack, to provide the power to the miniaturized charger circuits.

In example embodiments of the invention, a wireless rechargeable headset includes an ear piece speaker; a wireless transceiver coupled to the ear piece; a rechargeable battery coupled to the transceiver and ear piece; a wireless power receiving coil coupled to the rechargeable battery; and a high permeability magnetic field guide configured to direct an applied magnetic field from a high permeability magnetic field concentrator into the power receiving coil of the headset. The magnetic field guide is generally ring-shaped with a flat bottomed base that is juxtaposed with a pole of the concentrator and includes an upward extending wall that forms a flat-bottomed cavity with the base of the guide. The power receiving coil is wrapped around the guide to reduce fringe fields and urge the applied magnetic field in the power receiving coil into more nearly parallel paths.

Example embodiments of the invention may employ resonant magnetic coupling, considered a subset of inductive coupling. In resonant magnetic coupling, a first alternating current in a resonant receiving coil a self-resonant circuit in a utilization device, is tuned to resonate at substantially the same resonant frequency as a resonant transmitting coil in a self-resonant circuit of a wireless charger, the resonant receiving coil operating as a magnetically coupled resonator with the resonant transmitting coil. The separation distance between the two coils may be several times larger than the geometric sizes of the coils. In example embodiments of the invention, the resonant receiving coil is strongly coupled to the resonant transmitting coil when the resonant transmitting coil is driven at the resonant frequency common to both coils, even when a separation distance between the two coils is several times larger than geometric sizes of the coils.

### DESCRIPTION OF THE FIGURES

FIG. 1 illustrates an example embodiment for a wireless charging arrangement for a small rechargeable device's battery, such as in a wireless headset, employing an example high permeability magnetic field concentrator to match a proximate power transmitting coil having a relatively large surface area in a wireless charger, with a proximate power receiving coil having a relatively small surface area in a small rechargeable device, such as a wireless headset.

FIG. 2A illustrates an example embodiment for a wireless charger.

FIG. 2B illustrates an example embodiment for a small rechargeable device with a wrapped wire coil.

FIG. 2C illustrates an example embodiment for a small rechargeable device with a printed wire coil.

FIG. 3A illustrates an example embodiment for a magnetic field produced by power transmitting coil having a relatively large surface area in a wireless charger.

FIG. 3B illustrates an example embodiment for a magnetic field concentrated by a high permeability magnetic field concentrator positioned above a power transmitting coil having a relatively large surface area in a wireless charger.

FIG. 3C illustrates an example embodiment for a magnetic field concentrated by a high permeability magnetic field concentrator and directed into a power receiving wrapped wire coil having a relatively small surface area in a small rechargeable device.

FIG. 3D illustrates an example embodiment for a magnetic field concentrated by a high permeability magnetic field concentrator and directed into a power receiving printed wire coil having a relatively small surface area in a small rechargeable device.

FIG. 3E illustrates another example embodiment for a magnetic field concentrated by a toroidal shaped high permeability magnetic field concentrator positioned above a power transmitting coil having a relatively large surface area in a wireless charger.

FIG. 3F illustrates the example embodiment for a toroidal shaped high permeability magnetic field concentrator, with the concentrated magnetic field and directed into a power receiving wrapped wire coil having a relatively small surface area in a small rechargeable device.

FIG. 4A illustrates an example embodiment for a high permeability magnetic field guide for a wrapped wire coil, which helps direct a magnetic field concentrated by a high permeability magnetic field concentrator into a power receiving wrapped wire coil having a relatively small surface area in a small rechargeable device.

FIG. 4B illustrates the example embodiment of FIG. 4A, showing how the magnetic field guide directs the magnetic field into the wrapped wire coil to enhance the inductive coupling of the power receiving wrapped wire coil.

FIG. 4C illustrates the example embodiment of FIG. 4A, showing how the absence of the magnetic field guide causes a reduction in the magnetic field coupling the power receiving wrapped wire coil.

FIG. 4D illustrates an example embodiment for a coin-shaped magnetic field high permeability magnetic field guide for a printed wire coil, which helps direct a magnetic field concentrated by a high permeability magnetic field concentrator into a power receiving printed wire coil having a relatively small surface area in a small rechargeable device.

FIG. 4E illustrates the example embodiment of FIG. 4D, showing how the coin-shaped magnetic field magnetic field guide directs the magnetic field into the printed wire coil to enhance the inductive coupling of the power receiving printed wire coil.

FIG. 4F illustrates the example embodiment of FIG. 4D, showing how the absence of the magnetic field guide causes a reduction in the magnetic field coupling the power receiving printed wire coil.

FIG. 4G illustrates an alternate example embodiment, showing two coin-shaped magnetic field guides between which is sandwiched the printed wire receiving coil, the guide directing the magnetic field into the printed wire coil to enhance the inductive coupling of the power receiving printed wire coil.

FIG. 5A illustrates an example embodiment for a wireless charging arrangement wherein charger coils are disposed around the pole end of the concentrator, configured to produce an alternating magnetic field to inductively couple with the proximate receiving coil, using contact-less electromagnetic induction.

FIG. 5B illustrates an example embodiment for the magnetic field concentrator with miniaturized charger circuits.

FIG. 5C illustrates an example embodiment for a magnetic field produced by the charger coil of FIG. 5A.

FIG. 5D illustrates an example embodiment for a wireless charging arrangement with the charger coil charging the small rechargeable device, with the wireless charging circuits of FIG. 5A integrated into the concentrator structure.

FIG. 5E illustrates an example embodiment for charger coil producing an alternating magnetic field to inductively couple with a proximate power receiving coil of a device such as a cell phone, positioned below the base, using contact-less electromagnetic induction.

FIG. 5F illustrates an example embodiment for a housing covering the conical surface of the concentrator from the base toward the pole and forming a socket cavity above the pole configured to accept insertion of the power receiving coil of the small rechargeable device.

### DISCUSSION OF EXAMPLE EMBODIMENTS OF THE INVENTION

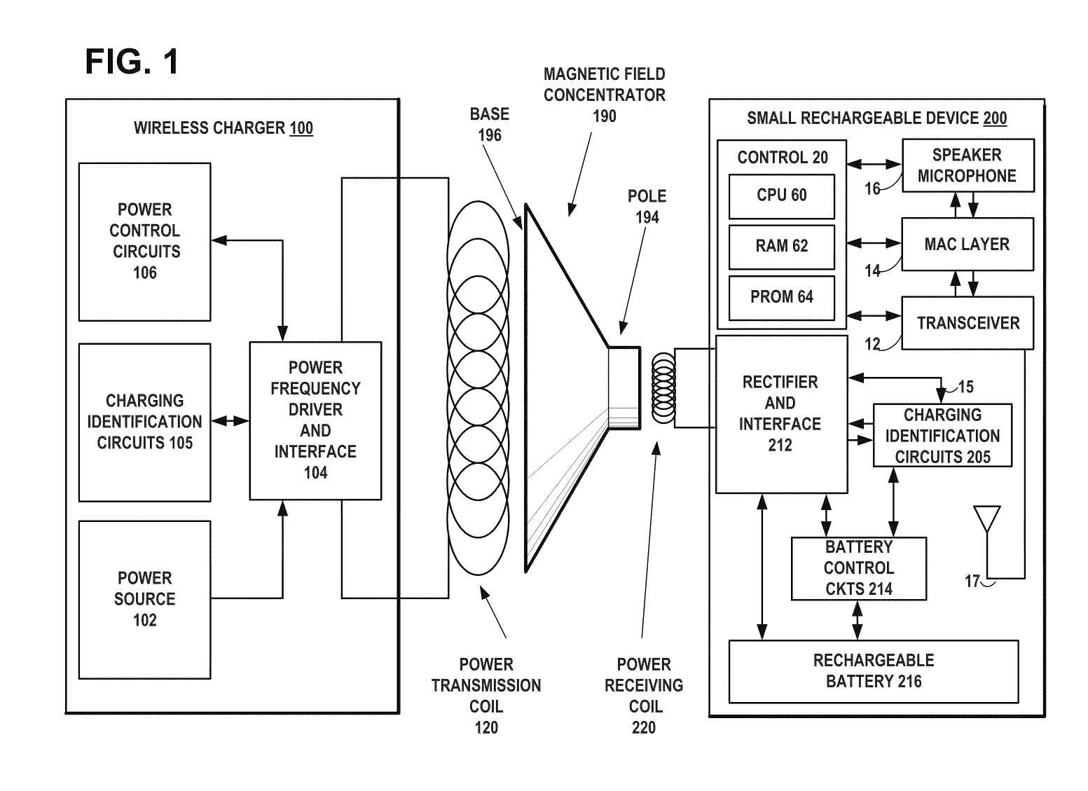

FIG. 1 illustrates an example embodiment for a wireless charging arrangement for a small rechargeable device's battery, such as in a wireless headset, employing an example high permeability magnetic field concentrator to match a proximate power transmitting coil having a relatively large surface area in a wireless charger, with a proximate power receiving coil having a relatively small surface area in a small rechargeable device, such as a wireless headset.

FIG. 1 illustrates an example embodiment for a wireless charging arrangement for a battery 216, employing a high permeability magnetic field concentrator 190 to match a proximate power transmitting coil 120 having a relatively large surface area in a wireless charger 100, with a proximate power receiving coil 220 having a relatively small surface area in a utilization device, such as a small rechargeable device 200. Permeability is the degree to which a material responds to an applied magnetic field and becomes magnetized. Materials that exhibit a high magnetic permeability are typically composed of ferromagnetic metals such as iron, cobalt, and/or nickel or compounds such as ferrite.

In an example embodiment, a power source circuit 102 in the wireless charging device 100 drives a power frequency driver and interface 104 that produces a source alternating current in a frequency range between 50 kHz and 20 MHz, which will provide energy to recharge the rechargeable batteries 216. The power control circuits 106 control the power level output by the charger 100. The charging identification circuits 105 identify the target current and voltage to be applied to each type of rechargeable battery 216.

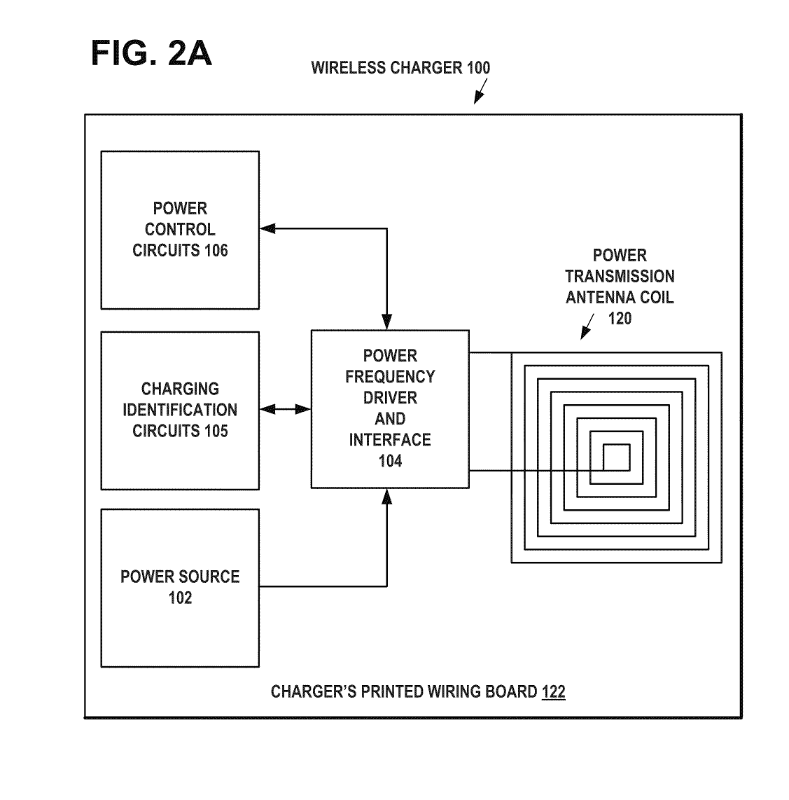

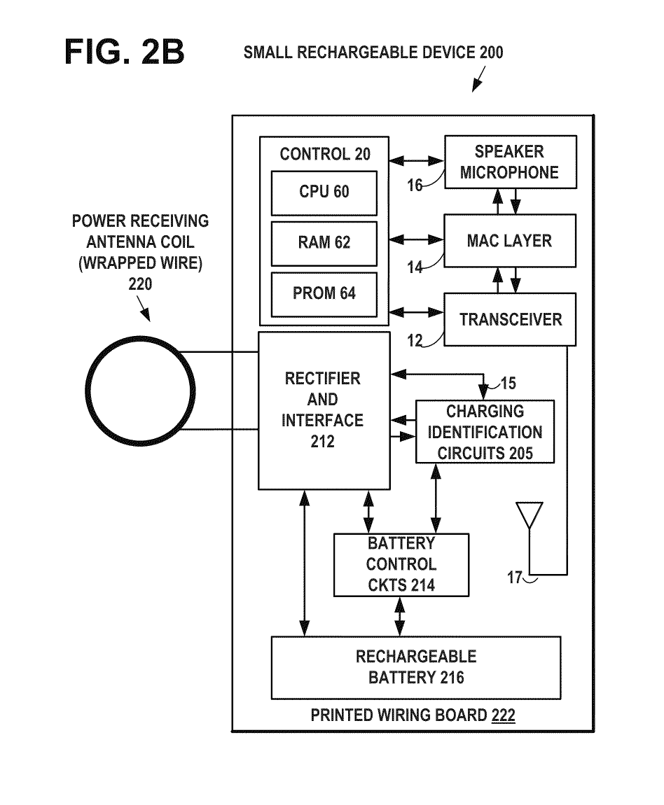

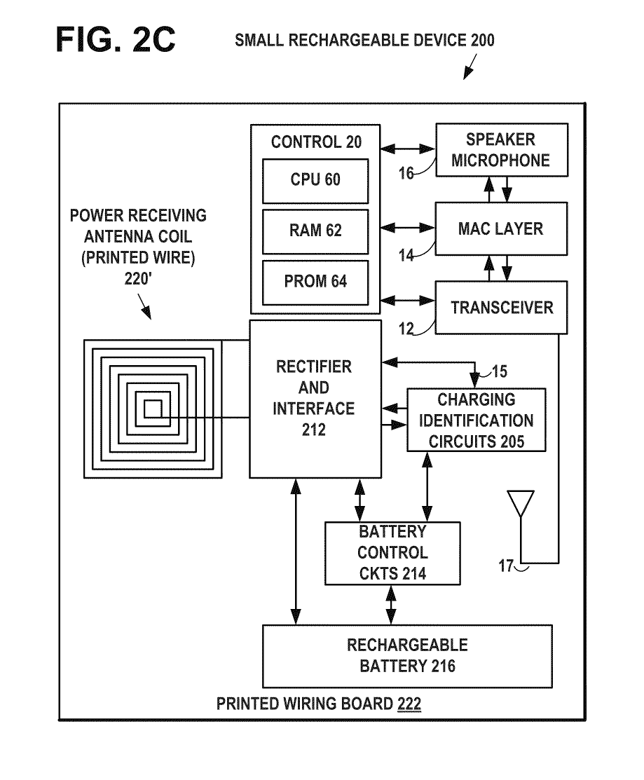

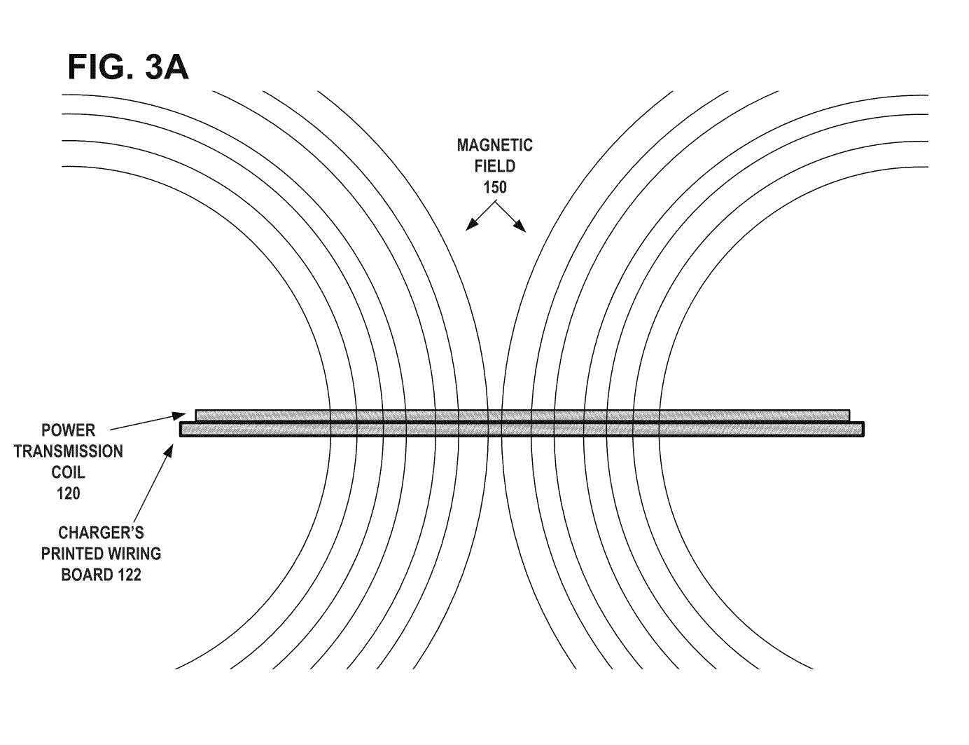

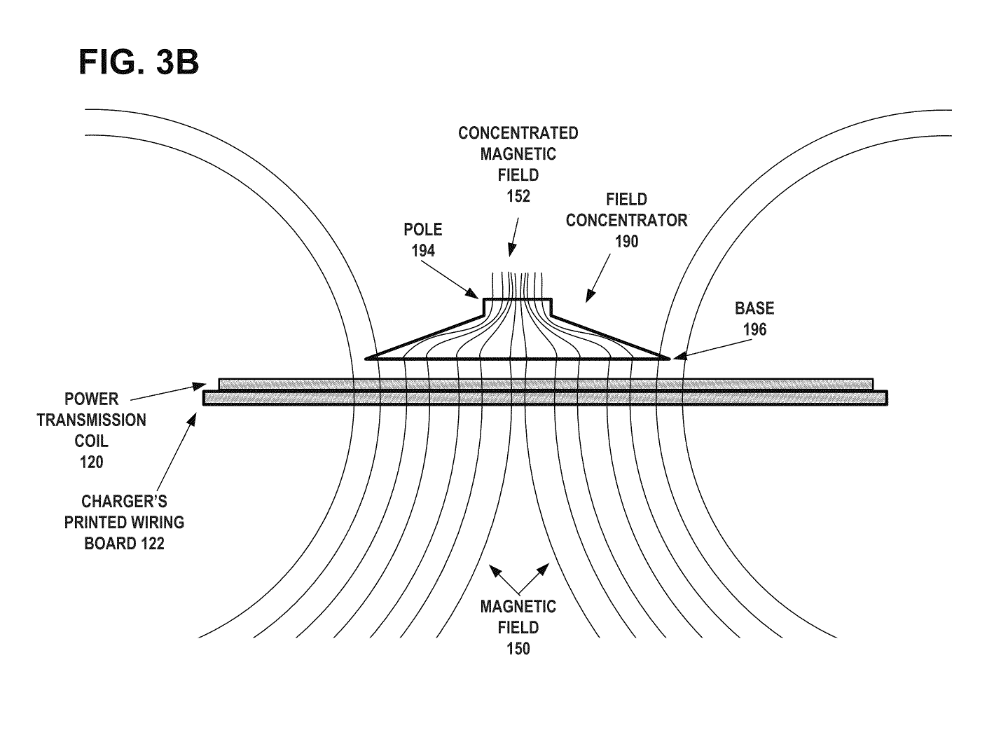

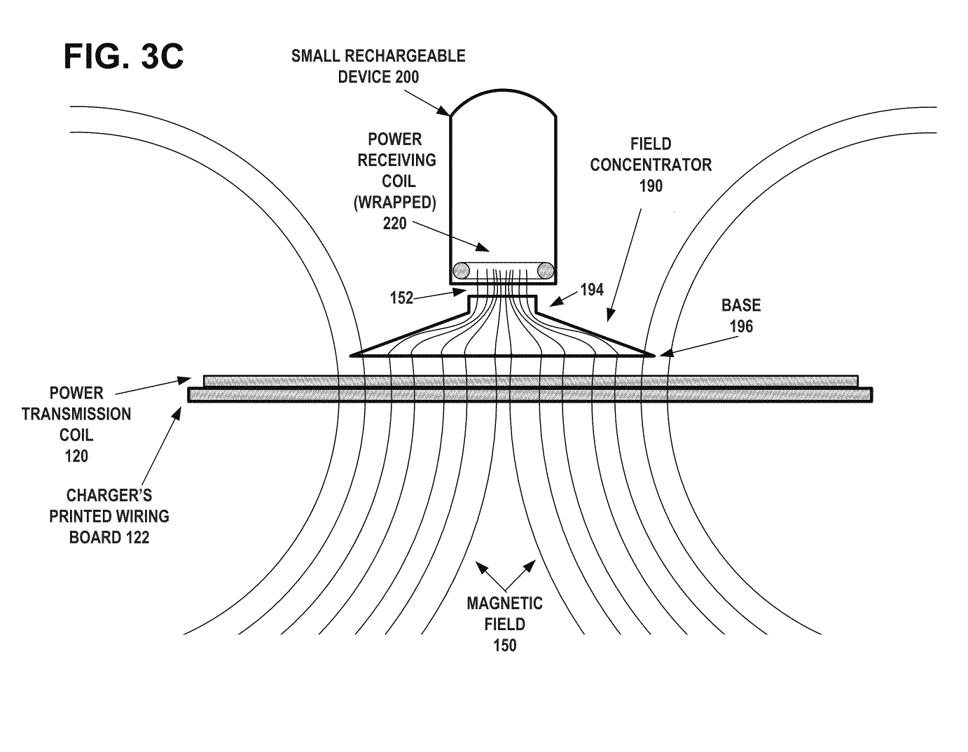

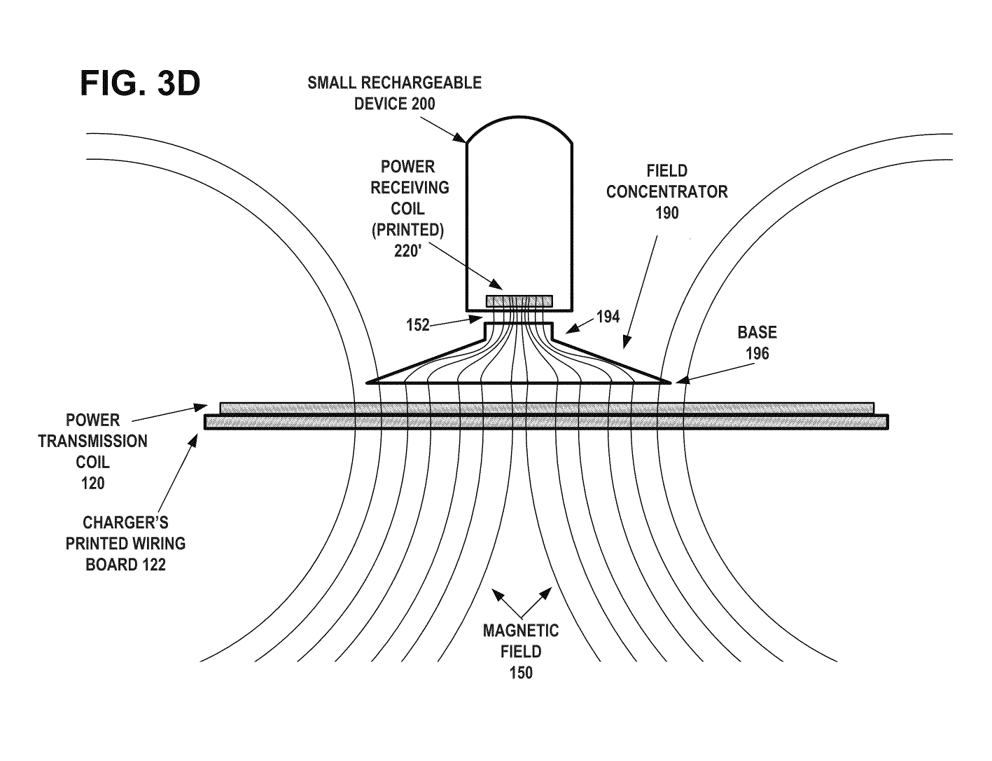

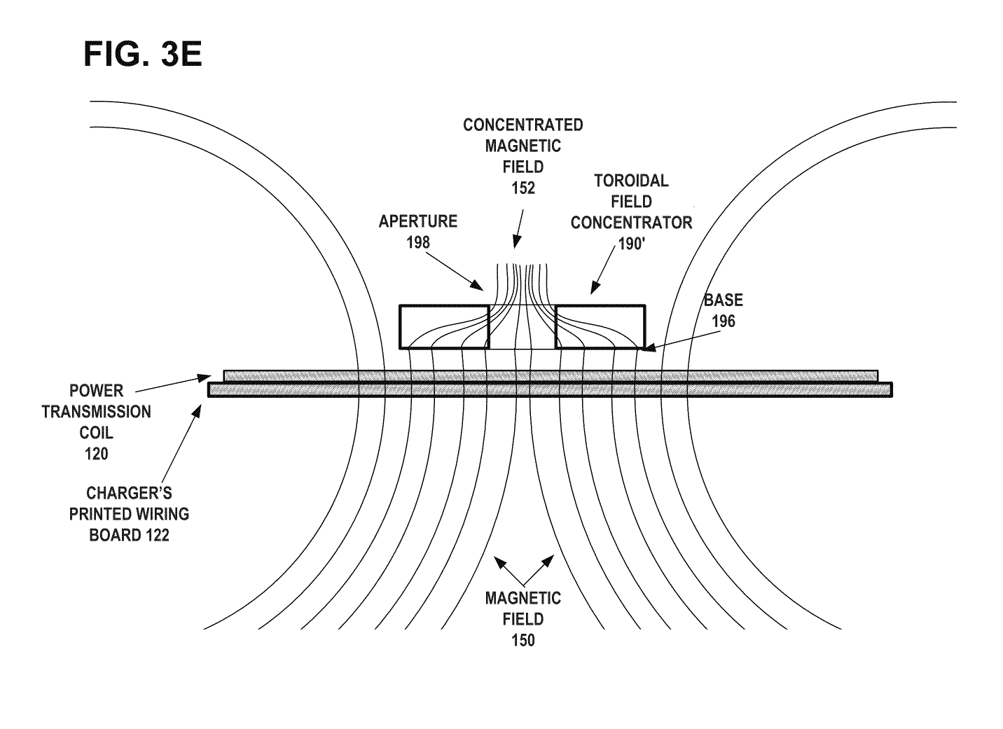

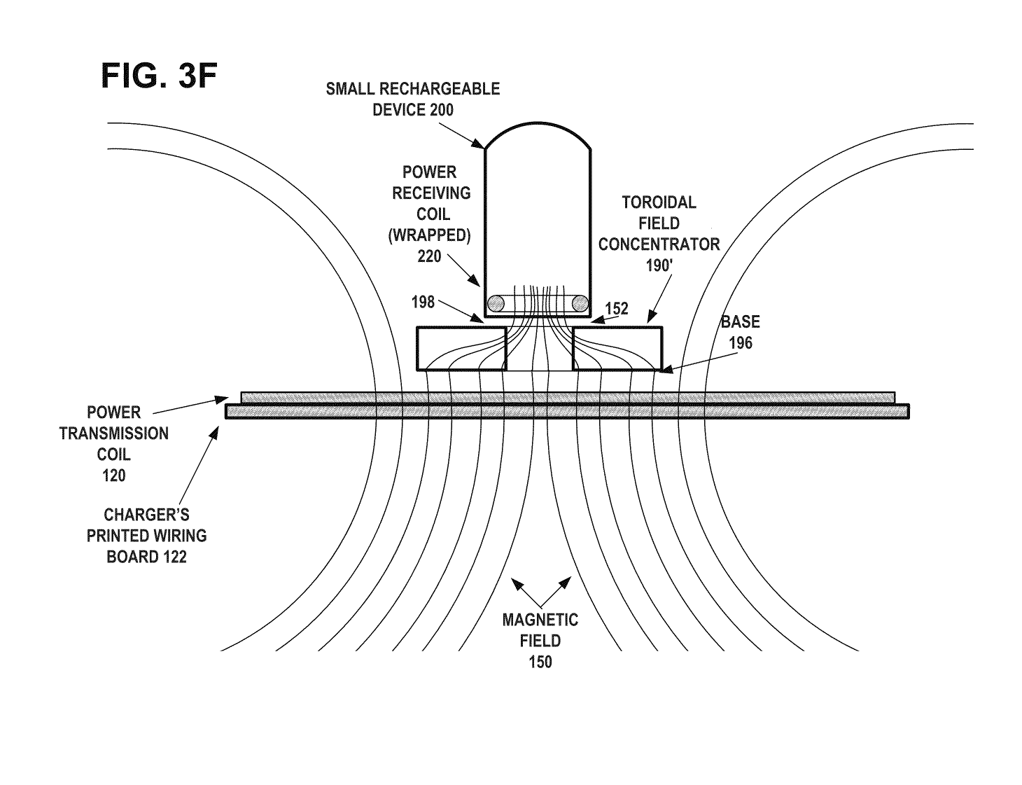

The transmit coil 120 may be any suitable shape such as printed coil, multilayer coils, wired antenna coils, and the like. FIG. 2A illustrates an example embodiment for a wireless charger with the power transmission antenna coil 120 being a printed wiring coil on a printed wiring board 122 shown as a relatively large charging plate in the side view of FIG. 3A. In alternate embodiments, a separate printed wiring board 122 may be omitted and the coil 120 may incorporated into the body of the printed wiring board or it may be glued to a plastic substrate forming the charging plate.

The relatively large area power transmission antenna coil 120 produces an alternating magnetic field 150 shown in FIG. 3A. The current carrying wires of the power transmission antenna coil 120 generate magnetic field lines 150 that form concentric circles around the wires 120. FIG. 3B illustrates the effect on the magnetic field 150 by placing the high permeability magnetic field concentrator 190 proximate to the power transmitting coil 120. In example embodiments of the invention, a high permeability magnetic field concentrator in an optimized shape to concentrate the magnetic field. Non-limiting examples include a generally frusto-conical shape and a generally toroidal shape.

An example frusto-conical shape for a magnetic field concentrator 190 has a generally frusto-conical shape with a base 196 at one end, tapering down to a pole 194 at the opposite end. The concentrator 190 is configured to concentrate magnetic flux 150 at a lower flux density incident at the base 196 produced by the proximate power transmitting coil 120 in the wireless charger 100. The magnetic flux density through a surface is proportional to the number of magnetic field lines that pass through the surface. The magnetic flux 152 exits at a higher flux density at the pole end 194 proximate to the power receiving coil 220, as shown in FIG. 3C. The higher density magnetic flux 152 couples with the power receiving coil 220, using contact-less electromagnetic induction. The magnetic field concentrator 190 enables gathering sufficient power by the relatively small power receiving coil 220 to charge the small rechargeable device's batteries 216 within a reasonable time.

An example toroidal shape for a magnetic field concentrator 190′ in FIG. 3E has a generally circular body with a base 196 and an upper surface, surrounding a generally circular aperture 198. The example toroidal shaped concentrator is configured to concentrate an applied magnetic flux 150 at a lower flux density incident at the base 196 from a proximate power transmitting coil 120 having a relatively large surface area in a wireless charger. The magnetic flux exits at a higher flux density 152 at the upper surface proximate to a power receiving coil 220 shown in FIG. 3F, having a relatively small surface area in a utilization device. The higher density magnetic flux couples with the power receiving coil, using contact-less electromagnetic induction.

Magnetic flux always forms a closed loop, but the path of the loop depends on the magnetic permeability of the surrounding materials. Magnetic flux is concentrated along the path of highest magnetic permeability. Air and vacuum have a low magnetic permeability, whereas easily magnetized materials such as soft iron have a high magnetic permeability. An applied magnetic field causes magnetic flux to follow the path of highest magnetic permeability. Since the magnetic field concentrator 190 has a higher magnetic permeability than the surrounding structures and the air above the power transmitting coil 120, it concentrates the magnetic flux 150 incident at the base 196 into the concentrated magnetic flux 152 that exits at the pole end 194, as shown in FIG. 3C. The composition of the high permeability magnetic field concentrator 190 may be an alloy of ferromagnetic metals such as iron, cobalt, and/or nickel or compounds such as ferrite. Mu-metal, a nickel-iron magnetic alloy with small amounts of copper and molybdenum, has a very high magnetic permeability approximately 20,000 times greater than that of air. Permalloy is a nickel-iron magnetic alloy with a high magnetic permeability approximately 8000 times greater than that of air. Silicon electrical steel or transformer steel has a high magnetic permeability approximately 4000 times greater than that of air. Ferrites are nickel, zinc, and manganese compounds used in transformer or electromagnetic cores, are suitable for frequencies above 1 MHz, and have a high magnetic permeability approximately 640 times greater than that of air.

The ferromagnetic material of the concentrator 190 should be chosen so that its magnetic permeability is high enough to carry the concentrated magnetic field 152 in the small cross sectional area at the pole 194, without magnetically saturating the material. When a ferromagnetic material is magnetized with a sufficiently strong magnetic flux density, the material becomes magnetically saturated. Ferromagnetic materials tend to saturate at a certain level based in part on the magnetic permeability of the material and the cross sectional dimensions of the material perpendicular to the magnetizing field. Typically, a ferromagnetic material with a higher magnetic permeability will have a higher saturation level. If the ferromagnetic material of the concentrator 190 becomes saturated, further increases in the applied magnetic field 150 produced by the power transmission coil 120 and incident at the base 196 of the concentrator 190, may not result in proportional increases in the concentrated magnetic field 152 at the pole 194. If the material in the cross sectional area at the pole 194 reaches saturation levels during peak moments of the AC sine wave cycle for the power transmission coil 120, the voltage induced in the power receiving coil 220 will no longer match the wave-shape of the voltage powering the power transmitting coil 120. If this happens, less than full power may be transferred to the power receiving coil 220.

FIG. 2B illustrates an example embodiment for a wirelessly charged small rechargeable device. The power receiving antenna coil 220 may be a wrapped wire coil as shown in FIG. 2B and FIG. 3C or it may be a printed circuit 220′ as shown in FIG. 2C and FIG. 3D. The printed wiring coil 220′ may be formed on a printed wiring board 222 shown in the side view in FIG. 3C. The printed wiring coil 220′ may be formed on a printed wiring board that may be a separate board from that which holds the remaining electronics. In alternate embodiments, a separate printed wiring board 222 may be omitted and the printed wire coil 220′ may be incorporated into the body of the printed wiring board or it may be glued to a plastic substrate in the small rechargeable device 200. The wireless power coils 120 and 220 are planar coils. The wireless power coils 120 and 220 are shown juxtaposed in FIG. 3C and FIG. 3D, coplanar to enable efficient inductive coupling by the compressed magnetic field 152.

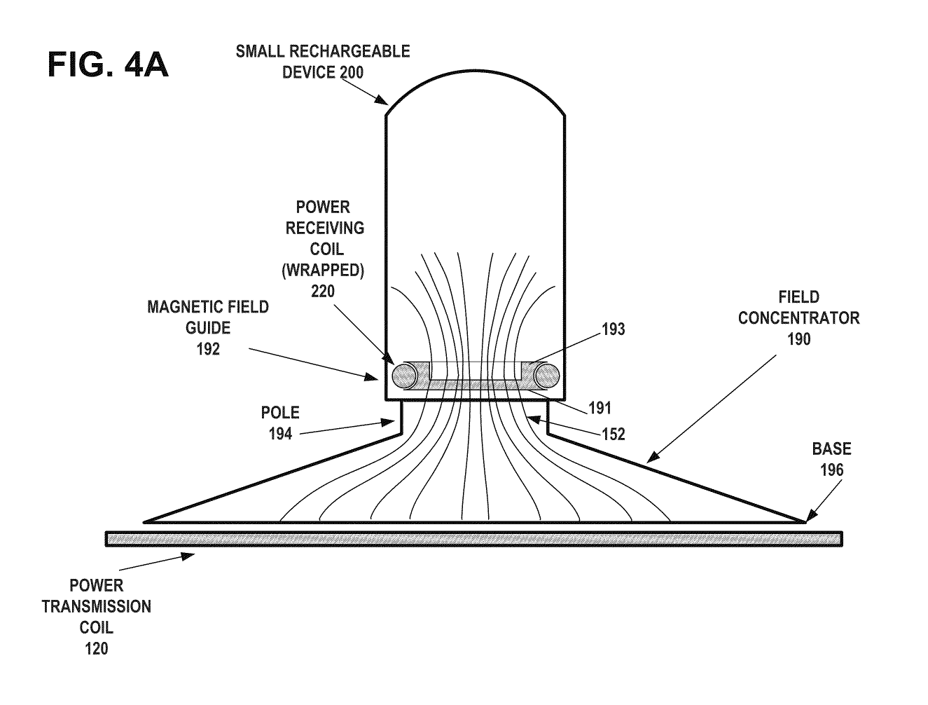

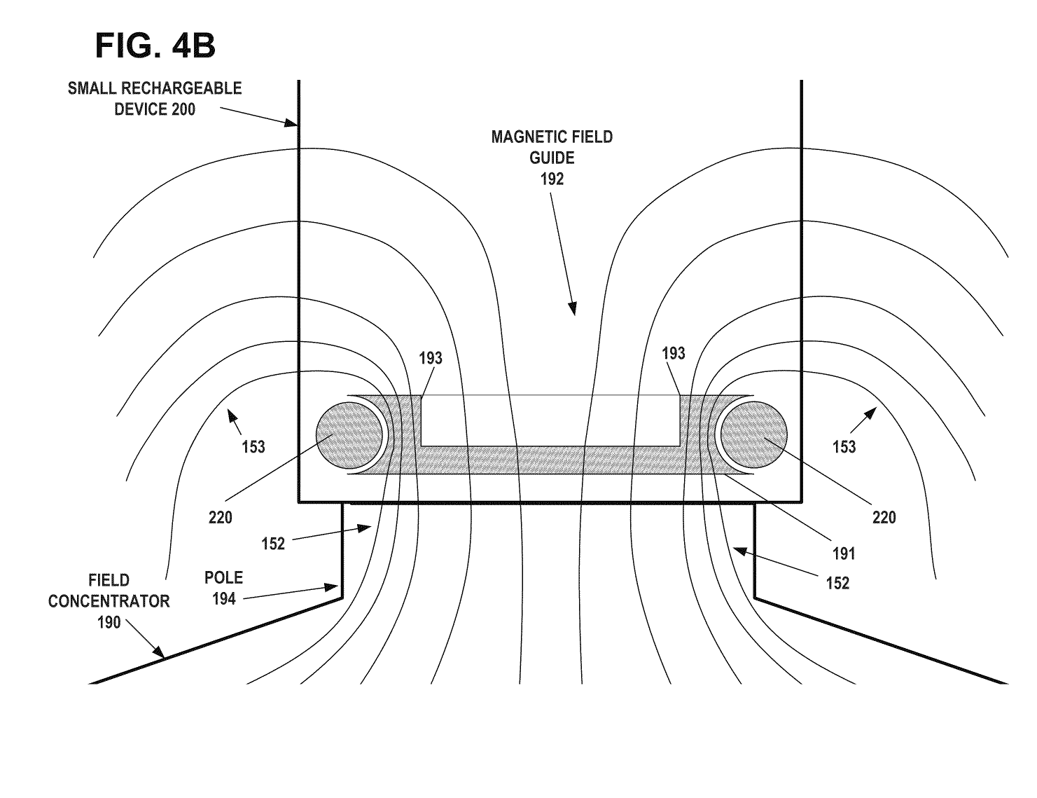

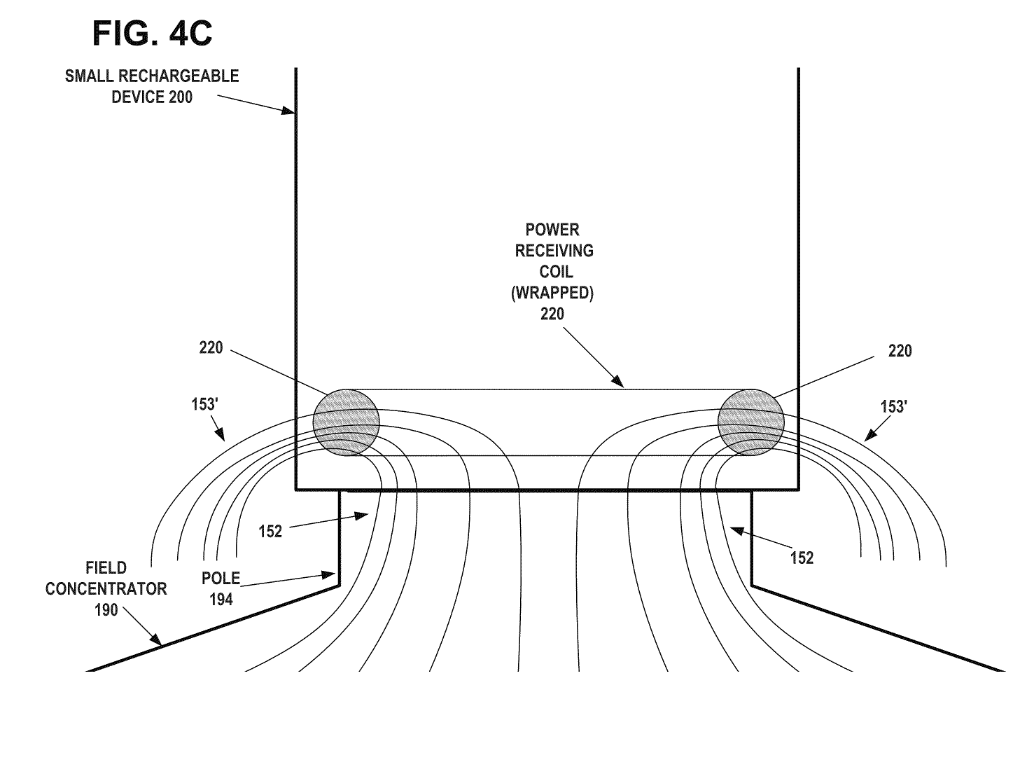

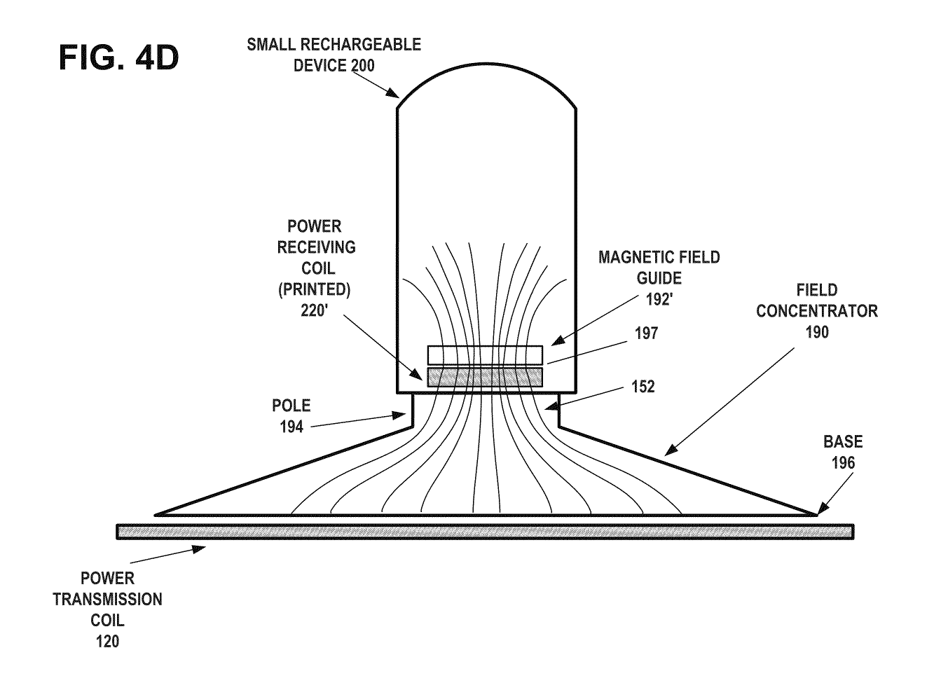

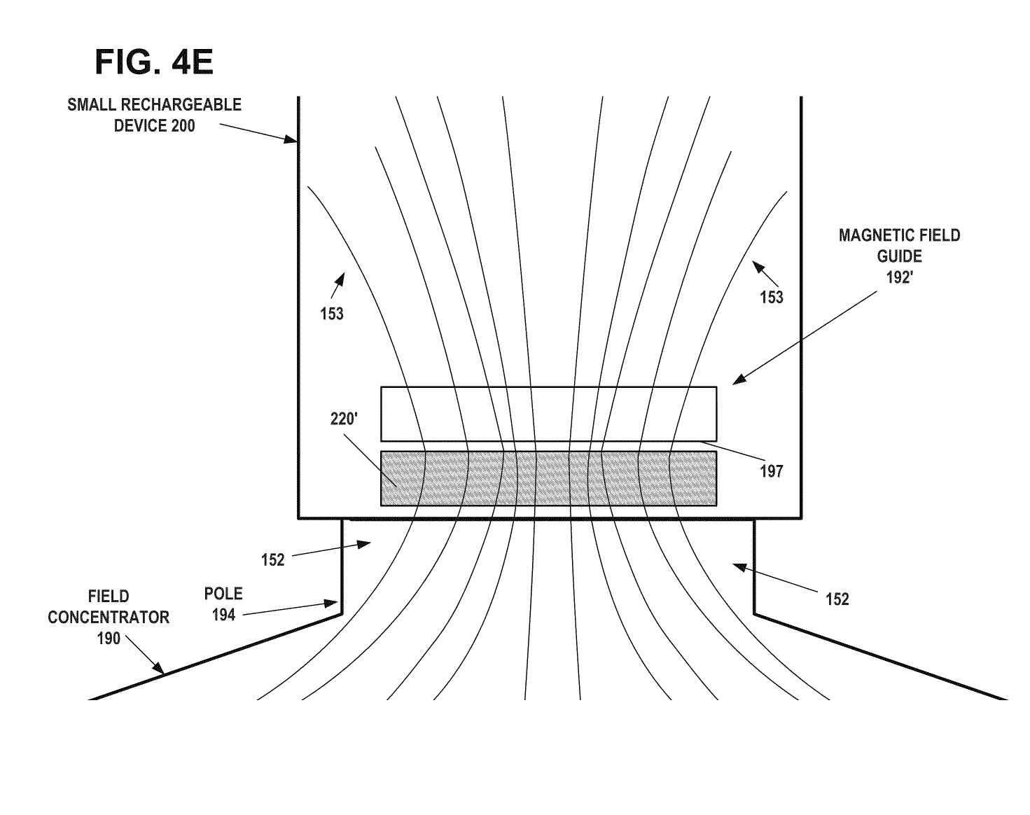

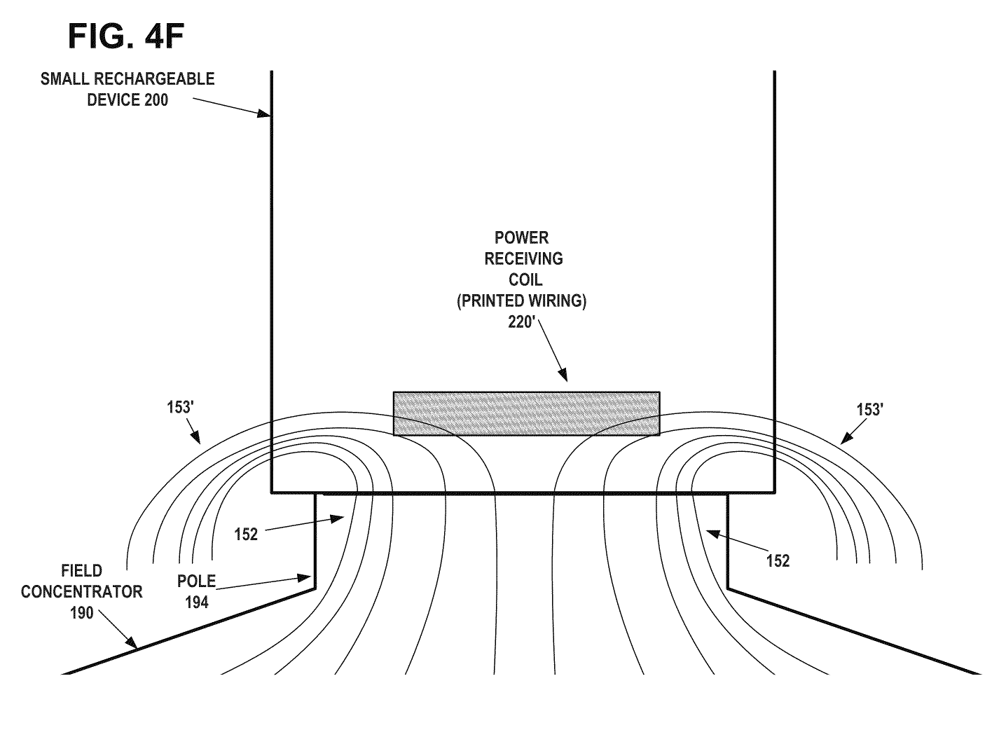

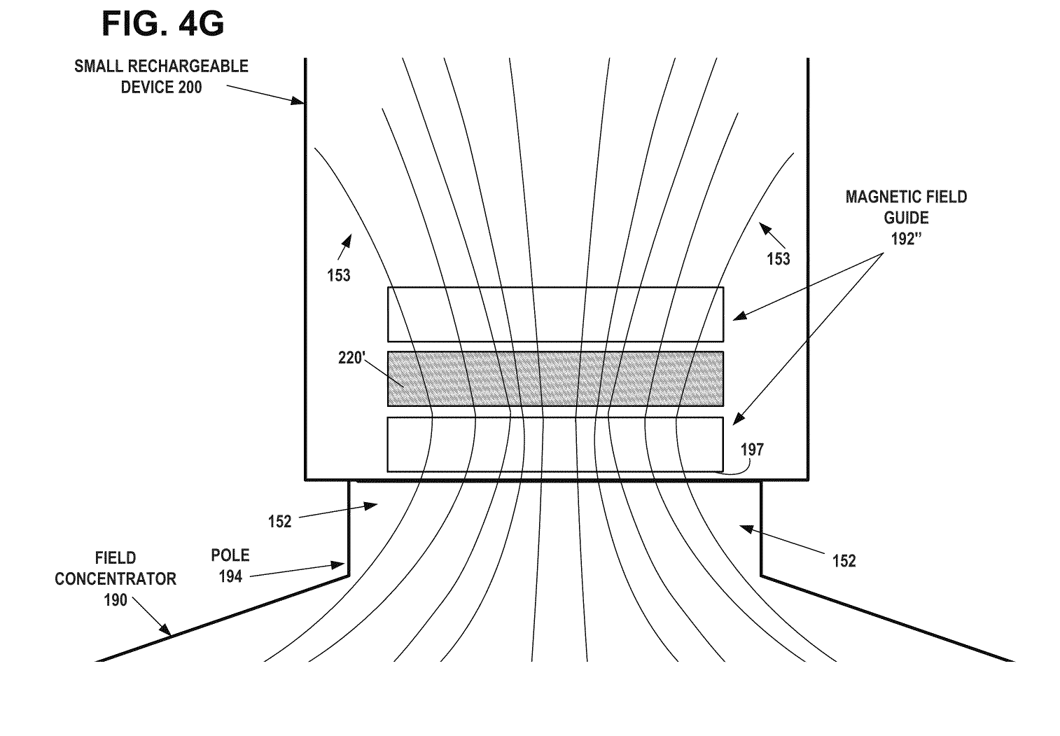

FIG. 4A illustrates an example embodiment for a high permeability magnetic field guide 192 that helps direct the magnetic field 152 concentrated by the high permeability magnetic field concentrator 190 into the power receiving wrapped wire coil 220. The high permeability magnetic field guide 192 reduces fringe fields and urges the concentrated magnetic field 152 in the power receiving coil 220 into more nearly parallel paths in the small rechargeable device 200. The magnetic field guide 192 is generally ring-shaped with a base 191 that is juxtaposed with the flat, upper surface of the pole 194 of the concentrator 190. The upward extending wall 193 of the ring-shaped magnetic field guide 192 forms a flat-bottomed cavity with the base 191 of the guide 192, and around the ring is mounted the power receiving wrapped wire coil 220 so as to be coplanar with the flat bottomed base 191 and juxtaposed with the pole 194. Since the high permeability magnetic field guide 192 has a higher magnetic permeability that the surrounding structures and the air above the pole 194 of the concentrator 190, it guides the concentrated magnetic flux 152 incident at the flat bottomed base 191 of the guide to reduce fringe fields and urge the concentrated magnetic field 152 in the power receiving coil 220 into more nearly parallel paths, as shown in FIG. 4A. The composition of the high permeability magnetic field guide 192 may be an alloy of ferromagnetic metals such as iron, cobalt, and/or nickel or a ferromagnetic compound such as ferrite.

FIG. 4B illustrates the example embodiment of FIG. 4A, showing how the magnetic field guide 192 directs the applied magnetic field 152 through the higher permeability medium of the guide 192 into the redirected magnetic field 153 that passes through the area occupied by the wrapped wire coil 220 to enhance the inductive coupling of the power receiving wrapped wire coil 220.

FIG. 4C illustrates the example embodiment of FIG. 4A, showing how the absence of the magnetic field guide 192 in the path of the applied magnetic field 152 substitutes the lower permeability air in the path resulting in less of the magnetic field 153′ passing through the area occupied by the wrapped wire coil 220 causing a reduction in the magnetic field coupling the power receiving wrapped wire coil.

FIG. 4D illustrates an example embodiment for a coin-shaped magnetic field high permeability magnetic field guide 192′ for a printed wire coil 220′, which helps direct a magnetic field concentrated by a high permeability magnetic field concentrator into a power receiving printed wire coil 220′ having a relatively small surface area in a small rechargeable device. Since the high permeability magnetic field guide 192′ has a higher magnetic permeability that the surrounding structures and the air above the pole 194 of the concentrator 190, it guides the concentrated magnetic flux 152 incident at the flat bottomed base 197 of the guide to reduce fringe fields and urge the concentrated magnetic field 152 in the power receiving coil 220′ into more nearly parallel paths, as shown in FIG. 4D.

FIG. 4E illustrates the example embodiment of FIG. 4D, showing how the magnetic field guide 192′ directs the applied magnetic field 152 through the higher permeability medium of the guide 192′ into the redirected magnetic field 153 that passes through the area occupied by the printed wire coil 220′ to enhance the inductive coupling of the power receiving printed wire coil 220′.

FIG. 4F illustrates the example embodiment of FIG. 4D, showing how the absence of the magnetic field guide 192′ in the path of the applied magnetic field 152 substitutes the lower permeability air in the path resulting in less of the magnetic field 153′ passing through the area occupied by the printed wire coil 220′ causing a reduction in the magnetic field coupling the power receiving printed wire coil 220′.

FIG. 4G illustrates an alternate example embodiment, showing two coin-shaped magnetic field guides 192″ between which is sandwiched the printed wire receiving coil 220′, the guide 192″ directing the magnetic field into the printed wire coil to enhance the inductive coupling of the power receiving printed wire coil.

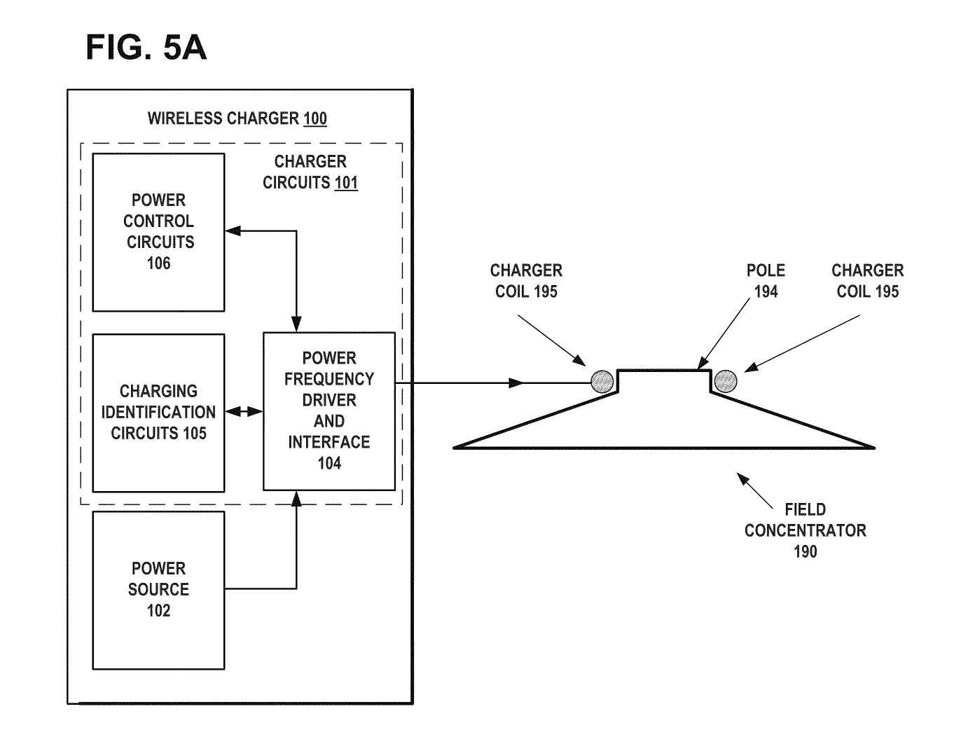

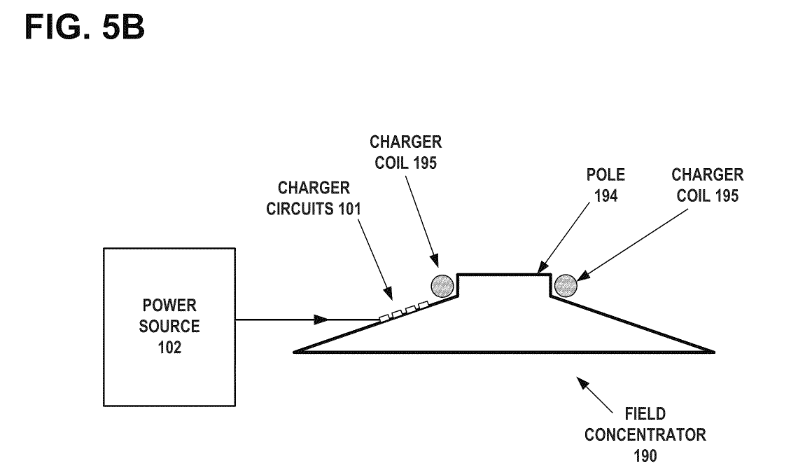

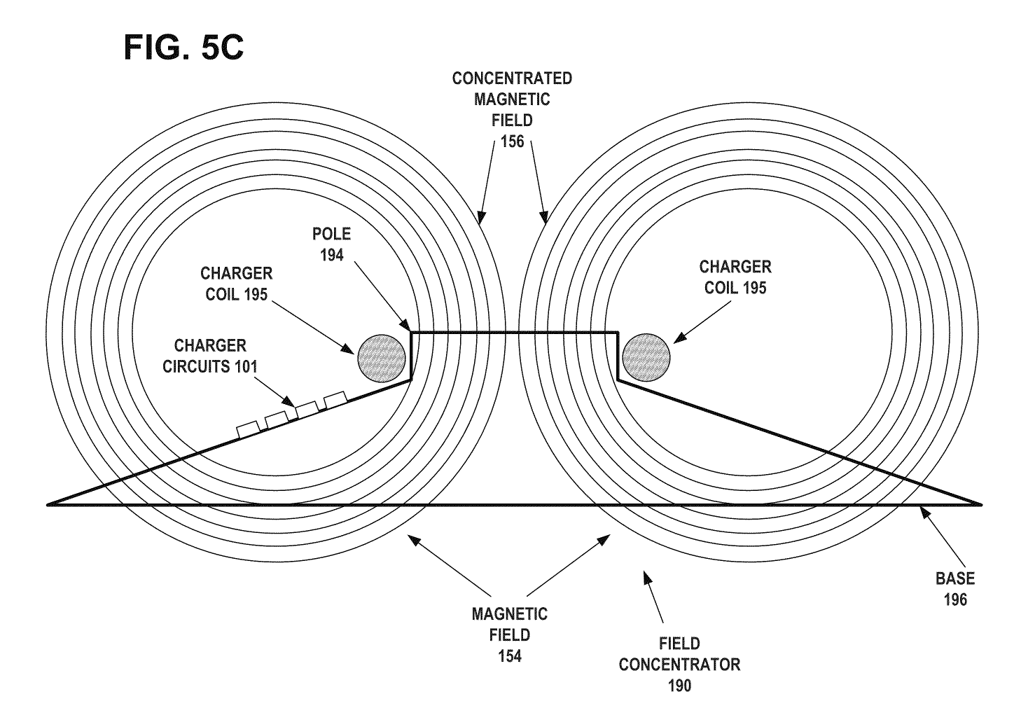

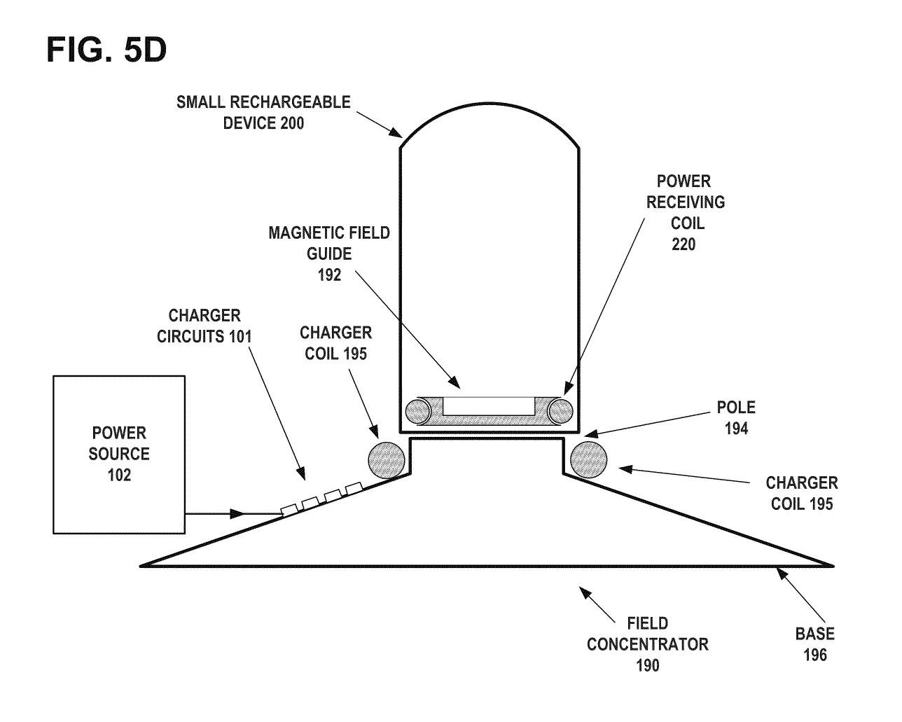

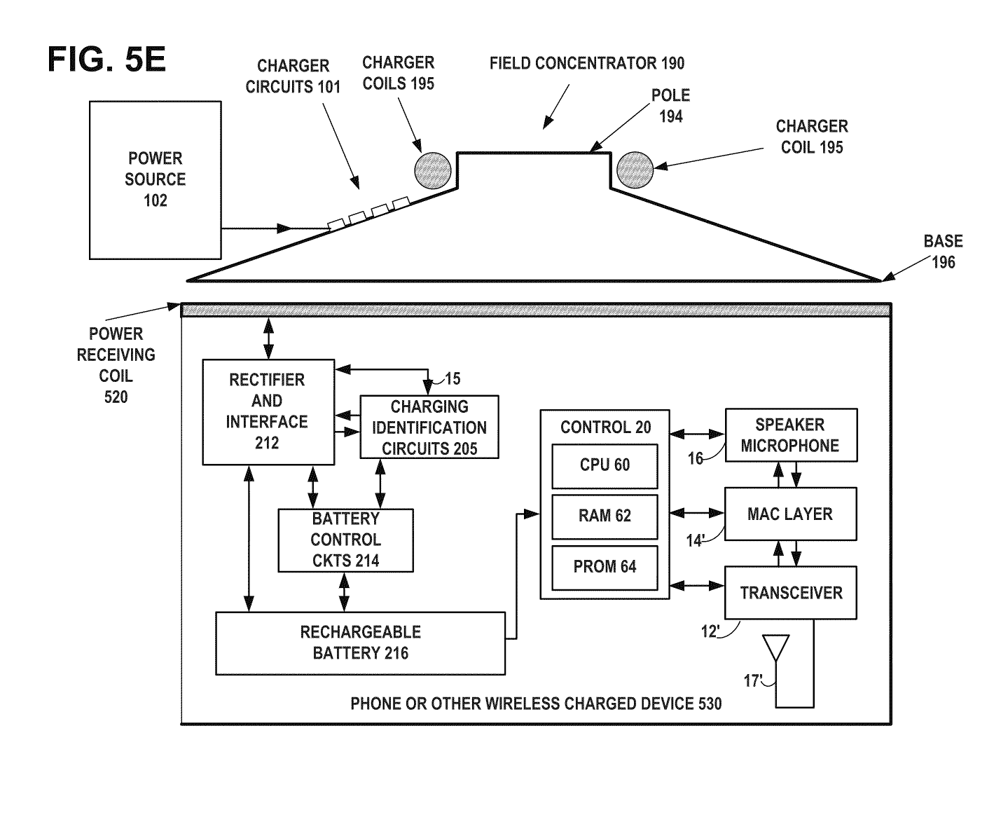

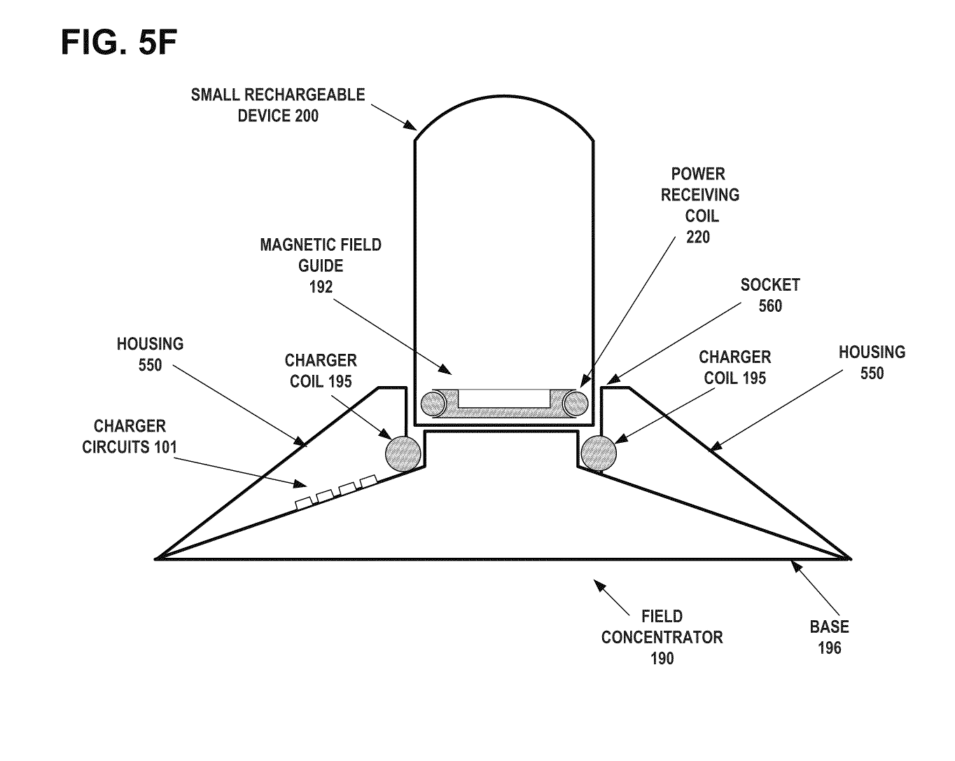

FIG. 5A illustrates an example embodiment for a wireless charging arrangement wherein charger coils 195 are wrapped wire around the pole end 194 of the concentrator 190, configured to produce an alternating magnetic field 156 shown in FIG. 5C, to inductively couple with the proximate receiving coil 220 in the small rechargeable device 200 shown in FIG. 5D, using contact-less electromagnetic induction. FIG. 5B illustrates an example embodiment for the magnetic field concentrator 190 with miniaturized charger circuits 101, such as large scale integrated (LSI) circuits on a printed wiring board, to perform the functions of the circuits 104, 105, and 106 of FIG. 5A. The power source 102 drives the power frequency driver and interface 104 that produces the source alternating current in a frequency range between 50 kHz and 20 MHz to the power transmission coil 120, which provides energy to recharge the rechargeable battery 216. The power control circuits 106 control the power level output by the charger circuits 101. The charging identification circuits 105 identify the target current and voltage to be applied to each type of rechargeable battery 216. The power source 102, such as a wall charger, mains, or a battery pack, provides the power to the miniaturized charger circuits 101.

FIG. 5E illustrates an example embodiment for charger coils 195 producing an alternating magnetic field 154 shown in FIG. 5C, beneath the base 196 of the concentrator 190, to inductively couple with a proximate power receiving coil 520 of a device such as a cell phone 530, positioned below the base 196, using contact-less electromagnetic induction.

FIG. 5F illustrates an example embodiment for a housing 550 covering the miniaturized charger circuits 101 on the printed wiring board and the conical surface of the concentrator 190 from the base 196 toward the pole 194, forming a socket cavity 560 above the pole 194, configured to accept insertion of the power receiving coil 220 of the small rechargeable device 200. The housing 550 may be a molded structure composed of a polymer such as epoxy.

FIGS. 1, 2B, and 2C show a functional block diagram of an example embodiment of the small rechargeable device 200. One, non-limiting example of a small rechargeable device is a wireless headset. A headset may or may not have all the following functions. The wireless headset 200 includes a control module 20, which includes a central processing unit (CPU) 60, a random access memory (RAM) 62, and a programmable read only memory (PROM) 64. Also included is a transceiver 12 for a Bluetooth antenna 17 to exchange voice signals with the user's cell phone. A MAC layer 14 provides the Bluetooth media access control functions. The speaker and microphone circuits 16 include digital-to-analog and analog-to-digital circuits and amplifier circuits to convert digital speech signals to analog sounds and vice versa. The rectifier and interface circuits 212 convert the induced alternating current in the power receiving coil 220 having a frequency range between 50 kHz and 20 MHz, into a DC voltage, which will provide energy to recharge the rechargeable battery 216. The battery control circuits 214 monitor the state of charge of the battery 216 and control the amount of charging current supplied to the battery. The charging identification circuits 205 identify the type of the battery 216 and communicate this information over a modulated carrier signal via the power receiving coil 220 and power transmission coil 120 to the charging identification circuits 105 in the wireless charger 100, to establish the limits for power delivery from the charger 100 to the headset 200 necessary to sufficiently charge the battery 216 without damaging it. The RAM 62 and ROM 64 can be removable memory devices such as smart cards, SIMs, WIMs, semiconductor memories such as RAM, ROM, PROMS, flash memory devices, etc. The MAC layer may be embodied as program logic stored in the RAM 62 and/or ROM 64 in the form of sequences of programmed instructions which, when executed in the CPU 60, carry out the functions of the disclosed embodiments. The program logic can be delivered to the writeable RAM, PROMS, flash memory devices, etc. 62 of the wireless device 200 from a computer program product or article of manufacture in the form of computer-usable media such as resident memory devices, smart cards or other removable memory devices. Alternately, the MAC layer and application program can be embodied as integrated circuit logic in the form of programmed logic arrays or custom designed application specific integrated circuits (ASIC).

Example embodiments of the invention may employ resonant magnetic coupling, considered a subset of inductive coupling. In resonant magnetic coupling, a first alternating current in a resonant receiving coil a self-resonant circuit in a utilization device, is tuned to resonate at substantially the same resonant frequency as a resonant transmitting coil in a self-resonant circuit of a wireless charger, the resonant receiving coil operating as a magnetically coupled resonator with the resonant transmitting coil. The separation distance between the two coils may be several times larger than the geometric sizes of the coils. In example embodiments of the invention, the resonant receiving coil is strongly coupled to the resonant transmitting coil when the resonant transmitting coil is driven at the resonant frequency common to both coils, even when a separation distance between the two coils is several times larger than geometric sizes of the coils.

Although specific example embodiments have been disclosed, a person skilled in the art will understand that changes can be made to the specific example embodiments without departing from the spirit and scope of the invention.

What is claimed is:

1. An apparatus, comprising:
a high permeability magnetic field concentrator having an optimized shape with a base and a top to concentrate a magnetic field, configured to concentrate an applied magnetic flux at a lower flux density incident at the base from a proximate power transmitting coil having a relatively large surface area in a wireless charger, the magnetic flux exiting at a higher flux density at the top proximate to a power receiving coil having a relatively small surface area in a utilization device.

2. The apparatus of claim 1, wherein the wireless charger is a charging plate and the utilization device is a small rechargeable device.

3. The apparatus of claim 1, which further comprises:
charger coils wrapped around the concentrator, configured to conduct alternating current to produce an alternating magnetic field to inductively couple with the proximate receiving coil, using contact-less electromagnetic induction.

4. The apparatus of claim 3, which further comprises:
said charger coils producing an alternating magnetic field below the base to inductively couple with a proximate power receiving coil of a device such as a cell phone, positioned below the base, using contact-less electromagnetic induction.

5. The apparatus of claim 3, wherein the charger coils are configured to conduct alternating current in a frequency range between 50 kHz and 20 MHz to produce the alternating magnetic field to inductively couple with the proximate receiving coil, using contact-less electromagnetic induction.

6. The apparatus of claim 1, which further comprises:
a housing covering the concentrator from the base toward the top and forming a socket cavity above the top configured to accept insertion of the power receiving coil of the utilization device.

7. The apparatus of claim 1, which further comprises:
miniaturized charger circuits mounted on the magnetic field concentrator to provide alternating current to charger coils disposed around the concentrator, the charger circuits receiving power from a wall charger, mains, or a battery.

8. The apparatus of claim 1, wherein the utilization device includes a high permeability magnetic field guide configured to direct the magnetic field concentrated by the high permeability magnetic field concentrator into the power receiving coil.

9. The apparatus of claim 1, wherein the high permeability magnetic field concentrator further comprises:
a generally frusto-conical shape with a base at one end, tapering down to a top at the opposite end, configured to concentrate an applied magnetic flux at a lower flux density incident at the base from a proximate power transmitting coil having a relatively large surface area in a wireless charger, the magnetic flux exiting at a higher flux density at the top proximate to a power receiving coil having a relatively small surface area in a utilization device.

10. The apparatus of claim 1, wherein the high permeability magnetic field concentrator further comprises:
a generally frusto-conical shape with a base at one end, tapering down to a top at the opposite end; and
charger coils wrapped around the top end of the concentrator, the coils being substantially concentric with the frusto-conical shape, configured to conduct alternating current to produce an alternating magnetic field to inductively couple with the power receiving coil in the utilization device juxtaposed with the top of the magnetic field concentrator, using contact-less electromagnetic induction;
said magnetic field concentrator configured to concentrate the magnetic field produced by the charger coils, the magnetic field exiting at a higher concentration at the top proximate to the power receiving coil.

11. The apparatus of claim 1, wherein the high permeability magnetic field concentrator further comprises:
a generally toroidal shape with a base and a top to concentrate a magnetic field, configured to concentrate an applied magnetic flux at a lower flux density incident at the base from a proximate power transmitting coil having a relatively large surface area in a wireless charger, the magnetic flux exiting at a higher flux density at the top proximate to a power receiving coil having a relatively small surface area in a utilization device.

12. The apparatus of claim 1, wherein the high permeability magnetic field concentrator is a ferromagnetic material selected from the group consisting of an alloy of iron, an alloy of cobalt, an alloy of nickel, and a ferrite compound.

13. The apparatus of claim 1, wherein the utilization device is selected from the group consisting of wireless headsets, hearing aids, cardiac pacemakers, small medical devices such as a pill-sized radio and camera for gastrointestinal diagnosis, small dental devices such as an ultraviolet light source for curing polymer dental fillings, wireless mouse, wearable ubiquitous computing devices, small surveillance cameras, illuminated jewelry, and battery-operated toys.

14. An apparatus, comprising:
a high permeability magnetic field guide in a utilization device, configured to direct an applied magnetic field from a high permeability magnetic field concentrator into a power receiving coil of the utilization device;
said magnetic field guide being juxtaposed with a top of the concentrator to reduce fringe fields and urge the applied magnetic field in the power receiving coil into more nearly parallel paths.

15. The apparatus of claim 14, wherein the utilization device is selected from the group consisting of wireless headsets, hearing aids, cardiac pacemakers, small medical devices such as a pill-sized radio and camera for gastrointestinal diagnosis, small dental devices such as an ultraviolet light source for curing polymer dental fillings, wireless mouse, wearable ubiquitous computing devices, small surveillance cameras, illuminated jewelry, and battery-operated toys.

16. The apparatus of claim 14, wherein said magnetic field guide is generally ring-shaped with a base that is juxtaposed with a top of the concentrator, and around the ring is wrapped the power receiving coil, to reduce fringe fields and urge the applied magnetic field in the power receiving coil into more nearly parallel paths, the power receiving coil being a wire coil wrapped around the periphery of the guide.

17. The apparatus of claim 14, wherein said magnetic field guide is generally coin-shaped with a flat bottomed base that is juxtaposed with a top of the concentrator, above which is mounted the power receiving coil, to reduce fringe fields and urge the applied magnetic field in the power receiving coil into more nearly parallel paths.

18. The apparatus of claim 14, wherein the magnetic field guide has two coin-shaped guides between which are sandwiched the power receiving coil, the two coin-shaped guides directing the magnetic field into the power receiving coil to enhance the inductive coupling of the power receiving coil.

19. The apparatus of claim 14, wherein the high permeability magnetic field concentrator is a ferromagnetic material selected from the group consisting of an alloy of iron, an alloy of cobalt, an alloy of nickel, and a ferrite compound.

20. The apparatus of claim 14, wherein the utilization device is selected from the group consisting of wireless headsets, hearing aids, cardiac pacemakers, small medical devices such as a pill-sized radio and camera for gastrointestinal diagnosis, small dental devices such as an ultraviolet light source for curing polymer dental fillings, wireless mouse, wearable ubiquitous computing devices, small surveillance cameras, illuminated jewelry, and battery-operated toys.

21. A system, comprising:
a high permeability magnetic field concentrator having an optimized shape with a base and a top to concentrate a magnetic field, configured to concentrate an applied magnetic flux at a lower flux density incident at the base from a proximate power transmitting coil having a relatively large surface area in a wireless charger, the magnetic flux exiting at a higher flux density at the top proximate to a power receiving coil having a relatively small surface area in a utilization device; and
a high permeability magnetic field guide in the utilization device, configured to direct the magnetic field concentrated by the high permeability magnetic field concentrator into the power receiving coil.

22. The system of claim 21, wherein the wireless charger is a charging plate and the utilization device is a small rechargeable device.

23. The system of claim 21, which further comprises:
charger coils wrapped around the top end of the concentrator, configured to conduct alternating current to produce an alternating magnetic field to inductively couple with the proximate receiving coil, using contact-less electromagnetic induction.

24. The system of claim 23, which further comprises:
said charger coils producing an alternating magnetic field below the base to inductively couple with a proximate power receiving coil of a device such as a cell phone, positioned below the base, using contact-less electromagnetic induction.

25. The system of claim 21, which further comprises:
miniaturized charger circuits mounted on the magnetic field concentrator to provide alternating current to charger coils disposed around the top end of the concentrator, the charger circuits receiving power from a wall charger, mains, or a battery.

26. The system of claim 21, which further comprises:
a housing covering the concentrator from the base toward the top and forming a socket cavity above the top configured to accept insertion of the power receiving coil of the utilization device.

27. A device, comprising:
a speaker;
a wireless transceiver coupled to the speaker;
a rechargeable battery coupled to the transceiver and speaker;
a wireless power receiving coil coupled to the rechargeable battery;
a high permeability magnetic field guide configured to direct an applied magnetic field from a high permeability magnetic field concentrator into the power receiving coil of the device;
said magnetic field guide being juxtaposed with a top of the concentrator to reduce fringe fields and urge the applied magnetic field in the power receiving coil into more nearly parallel paths.

28. The device of claim 27, wherein said magnetic field guide is generally ring-shaped with a base that is juxtaposed with a top of the concentrator, and around the ring is wrapped the power receiving coil, to reduce fringe fields and urge the applied magnetic field in the power receiving coil into more nearly parallel paths, the power receiving coil being a wire coil wrapped around the periphery of the guide.

29. The device of claim 27, wherein said magnetic field guide is generally coin-shaped with a flat bottomed base that is juxtaposed with a top of the concentrator, above which is mounted the power receiving coil, to reduce fringe fields and urge the applied magnetic field in the power receiving coil into more nearly parallel paths.

30. The device of claim 27, wherein the magnetic field guide has two coin-shaped guides between which are sandwiched the power receiving coil, the two coin-shaped guides directing the magnetic field into the power receiving coil to enhance the inductive coupling of the power receiving coil.
